(19) United States
(12) Patent Application Publication
(10) Pub. No.: US 2011/0273041 A1
(43) Pub. Date: Nov. 10, 2011

(54) ELECTRICITY-GENERATING DEVICE

(76) Inventors: HUAN-CHING TSENG, Chiayi County (TW); Chiun-Liang Tsai, Chiayi (TW); Chun-Hsin Tsai, Chiayi (TW)

(21) Appl. No.: 12/776,693

(22) Filed: May 10, 2010

(51) Int. Cl. H02K 1/06; H02K 9/06; H02K 3/28

(52) U.S. Cl. 310/62; 310/179

(57) ABSTRACT

An electricity-generating device has a rotator unit has a rotator, multiple magnetic strips and a shaft and has a stator unit comprising multiple annular steel sheets, a positioning post, multiple dividing boards, multiple insulating sheets, an inner coil and an outer coil. The shaft is connected to a drive motor and receives power from the drive motor so that the rotator unit rotates inside the stator unit of energy-generating device. By continuously shearing to perform electromagnetic inducement interaction, induced current is generated to output and to supply battery charge and outside electrical consumption or to actuate multiple electricity-generating modules arranged in parallel.

### BACKGROUND OF THE INVENTION

1. Field of the Invention

The present invention relates to an electricity-generating device, and more particularly to an electricity-generating device that is an energy-generating device comprising a rotator unit and a stator unit and connects a drive motor by the rotator unit and receives the power from the drive motor to generate current output by electromagnetic inducement.

2. Description of Related Art

Conventional electricity-generating devices mostly adapt conventional ways of consuming nature resources to transform energy from various resources to electricity. Therefore, consumption of the nature resources is huge and causes many sequential environmental and pollution problems. The drawbacks are:

1. Electricity-generating process consumes huge nature resources, which will be exhausted soon.

2. The pollutant caused during the electricity-generating process pollutes water and air.

3. Building of energy factor cause damage to nature environment, water and soil.

4. Electricity-generating cost is expensive and the fuel is difficult to obtain and has variations.

5. Other substitutional energy such as solar energy or wind energy that is not stably supplied during the electricity-generating process.

6. Waste cause by the electricity-generating process cannot be treated easily and causes environment pollution.

Although conventional electricity-generating device enables to achieve fundamental requirement and efficiency in respect of electricity-generating application, it still has drawbacks and insufficiency about environmental issue, stability, economic and development efficiency, and exclusivity of industrial application so that it cannot develop more specific industrial application.

### SUMMARY OF THE INVENTION

A main objective of the present invention is to provide an electricity-generating device that is an energy-generating device comprising a rotator unit and a stator unit and connects a drive motor with the rotator unit and receives the power from the drive motor to generate current output by electromagnetic inducement.

To achieve the foregoing objective, the electricity-generating device comprises:

a rotator unit having a rotator, multiple magnetic strips and a shaft, wherein the shaft penetrates the rotator and the multiple magnetic strips are mounted around an cylindrical surface of the rotator;

a stator unit having multiple annular steel sheets, a positioning post, multiple dividing boards, multiple insulating sheets, an inner coil and an outer coil; wherein the each of the multiple annular steel sheets has multiple T-openings; the multiple annular steel sheets are stacked to make the T-openings communicated to perform multiple T-recesses; the positioning post has multiple positioning strips erectly arranged in circle cross-section and multiple positioning recesses are defined each between adjacent two of the multiple positioning strips; each of the multiple dividing boards has multiple slits and two side ends having two ribs respectively to engage with a corresponding one of the multiple T-recesses and a corresponding one of the multiple positioning recesses respectively; each of the multiple insulating sheets is clamped between adjacent two of the multiple dividing boards and shaped in U-shape having a space and two distal ends at opening respectively inserted into adjacent two of the multiple positioning recesses; the space accommodates the inner coil or the outer coil penetrating the space;

two caps mounted on two ends of the shaft respectively and each having an end hole and a bearing around the end hole.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of an electricity-generating device in accordance with the present invention;

FIG. 2 is an exploded perspective view of the electricity-generating device in accordance with the present invention;

FIG. 3 is an exploded perspective view of a rotator unit in the present invention;

FIG. 4 is a perspective view of the rotator unit assembled in the present invention;

FIG. 5 is a perspective view of a stator unit in the present invention;

FIG. 6 is a cross-sectional view of the stator unit along with line A-A in FIG. 1;

FIG. 7 is a cross-sectional view of the stator unit along with line B-B in FIG. 1;

FIG. 8 is a schematic view showing arrangement of an inner coil and an outer coil;

FIG. 9 is an exploded perspective view of the frame of the stator unit without the inner coil and outer coil;

FIG. 10 shows schematic blocks of construction to supply multiple electricity applications; and

FIG. 11 shows schematic blocks of construction to expand with more electricity-generating modules

### DETAILED DESCRIPTION OF THE PREFERRED EMBODIMENT

An electricity-generating device has a rotator unit comprises a rotator, multiple magnetic strips and a shaft and has a stator unit comprising multiple annular steel sheets, a positioning post, multiple dividing boards, multiple insulating sheets, an inner coil and an outer coil. The shaft is connected to a drive motor and receives power from the drive motor so that the rotator unit rotates inside the stator unit of energy-generating device. By continuously shearing to perform electromagnetic inducement interaction, induced current is generated to output and to supply battery charge and outside electrical consumption or to actuate multiple electricity-generating modules arranged in parallel.

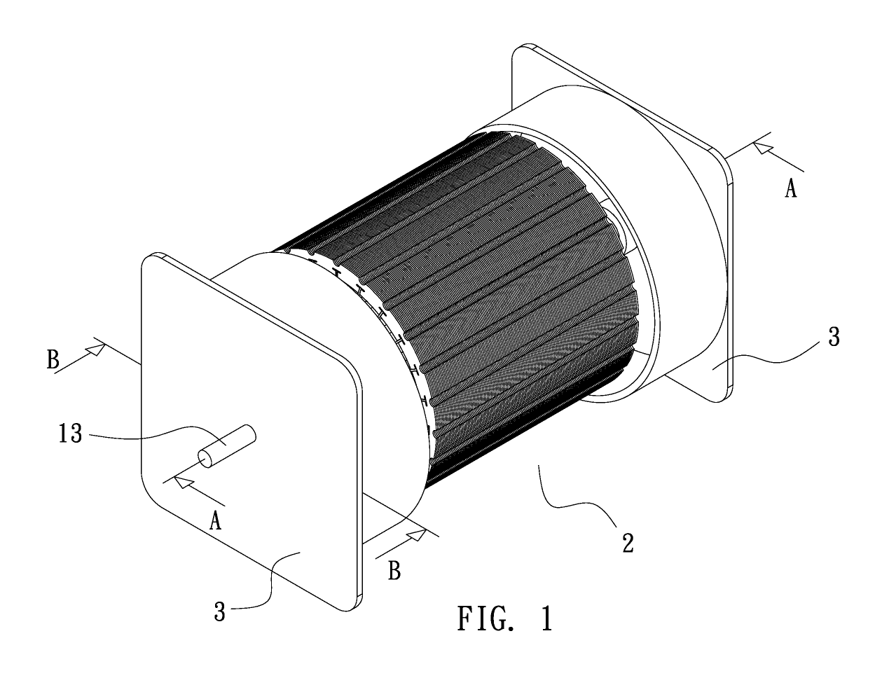

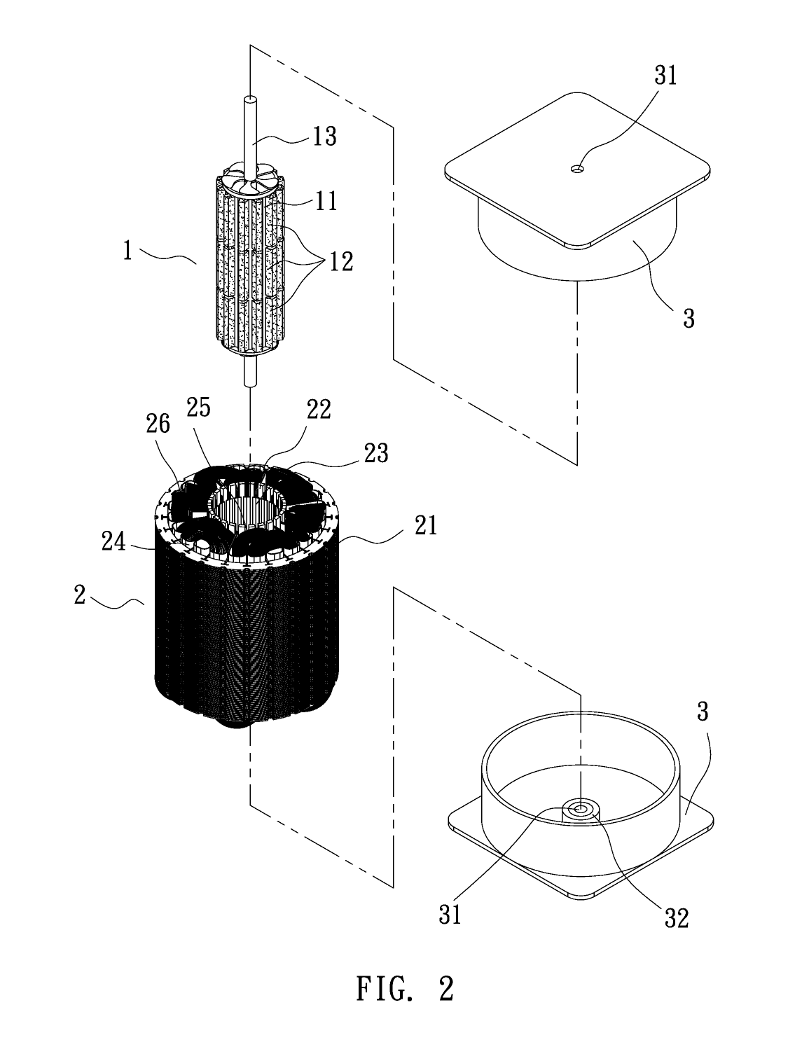

As shown in FIGS. 1 and 2, a preferred embodiment of a mainframe of the electricity-generating device in accordance with the present invention comprises a rotator unit 1, a stator unit 2 and two end caps 3, wherein:

The rotator unit 1 contains a rotator 11, multiple magnetic strips 12 and a shaft 13.

The stator unit 2 contains multiple annular steel sheets 21, a positioning post 22, multiple dividing boards 23, multiple insulating sheets 24, an inner coil 25 and an outer coil 26.

The two end caps 3 each contain an end hole 31 and a bearing 32 penetrated by the shaft 13.

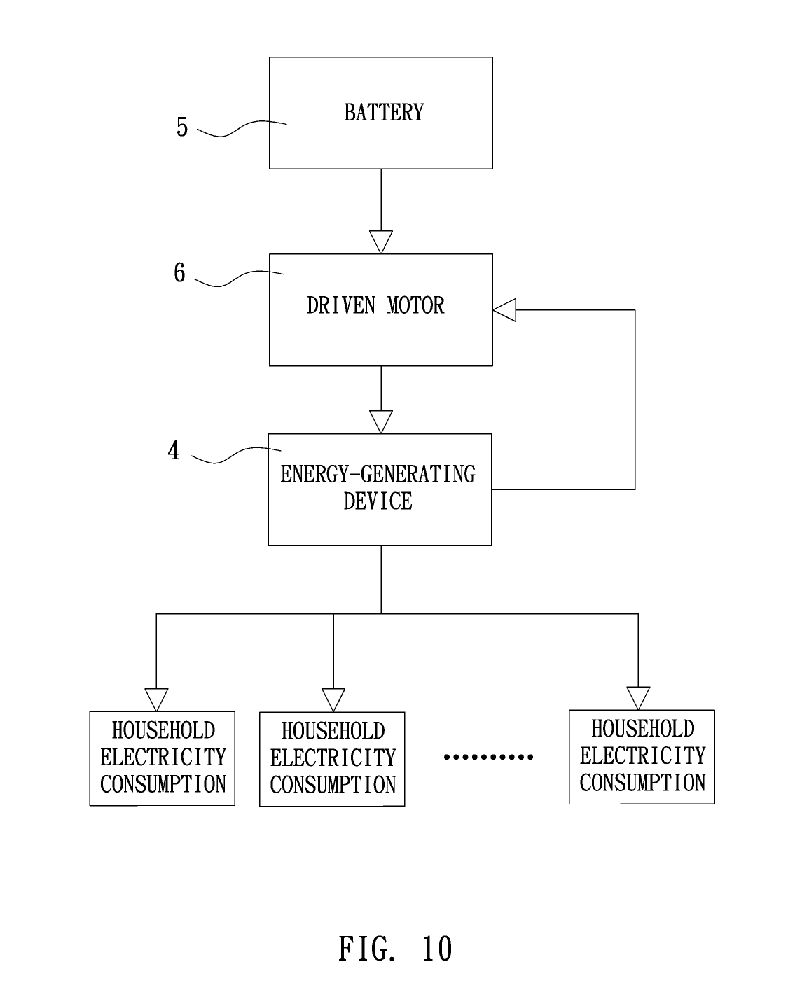

The rotator unit 1 is surrounded inside the stator unit 2. Two ends of the stator unit 2 engage the two end caps 3 respectively. The shaft 13 extends its two ends out of the two end caps 3 respectively (adapted to electrically connect to a drive motor 6, as shown in FIG. 10).

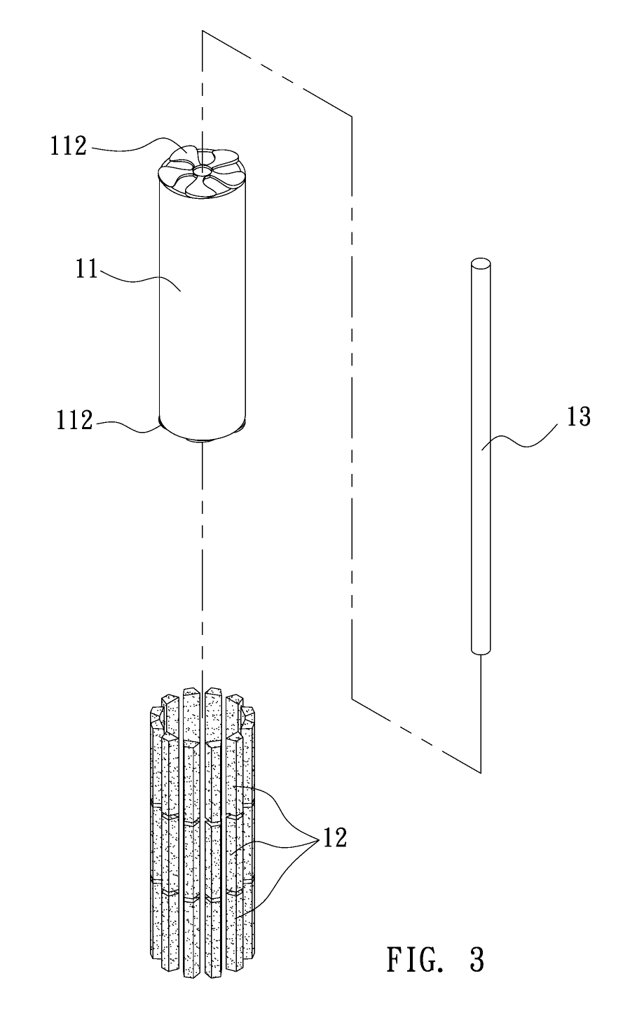

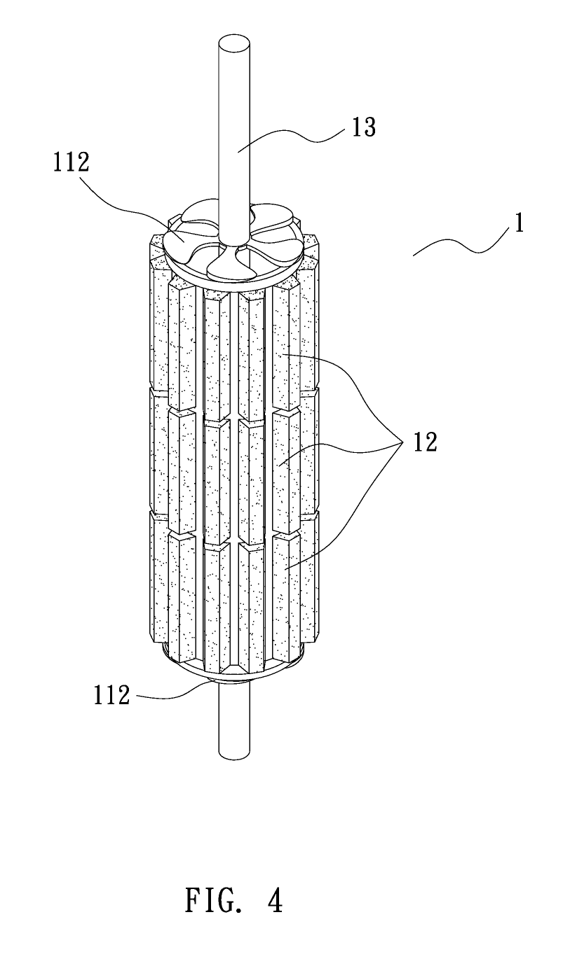

As shown in FIGS. 3 and 4, a preferred embodiment of the rotator unit 1 in the electricity-generating device of the present invention is shown, wherein the rotator unit 1 comprises a rotator 11, multiple magnetic strips 12 and a shaft 13. The shaft 13 penetrates the rotator 11. The multiple magnetic strips 12 are arranged around the rotator 11 around a cylindrical surface of the rotator 11.

The rotator 11 of the rotator unit 1 is solid or hollow in interior. If the rotator 11 is hollow, two ends of the rotator 11 are mounted two propellers 112 respectively and the multiple magnetic strips 12 are same length with the rotator 11 but each divided into multiple even sections.

The propellers 112 and the divided magnetic strips 12 sufficiently reduce the temperature of the rotator 11 and increase the magnetic flux density.

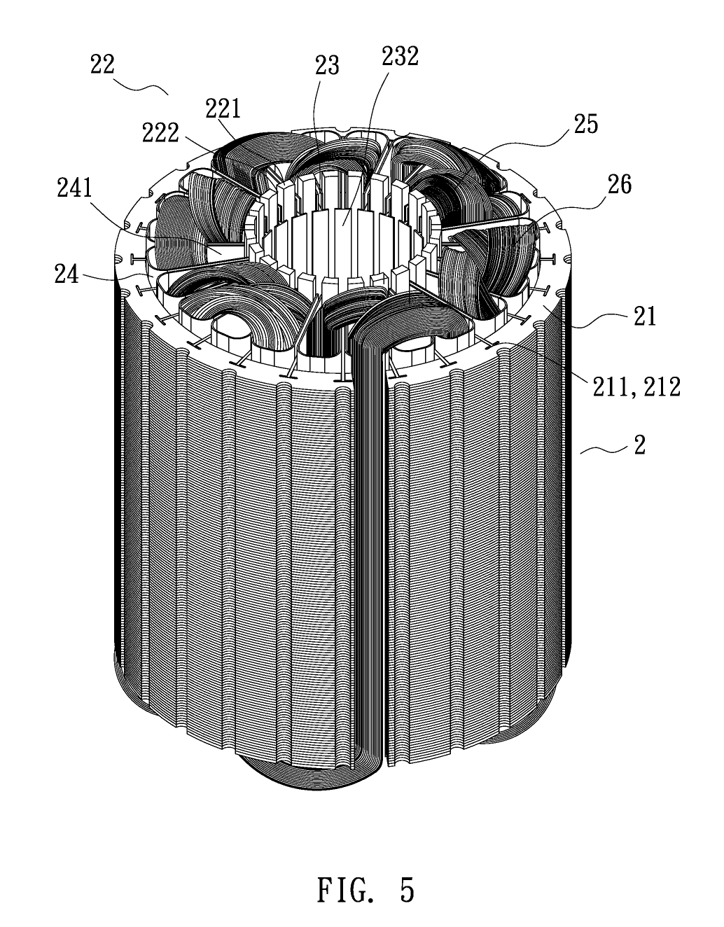

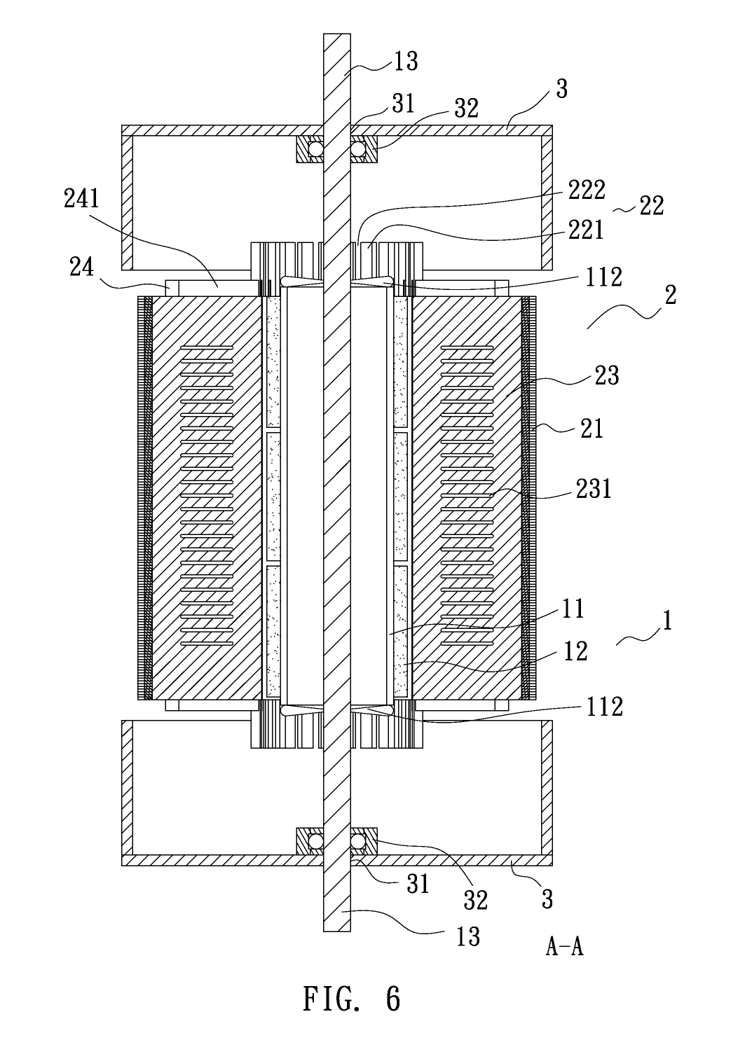

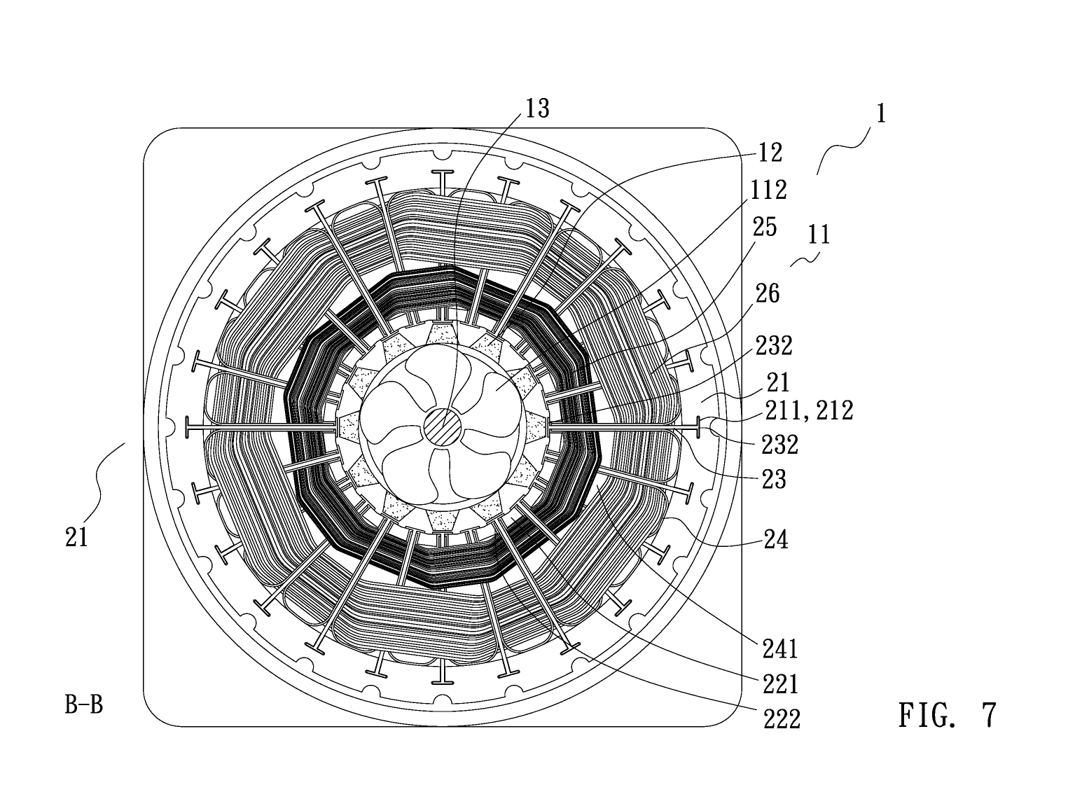

As shown in FIGS. 5 to 7, a detail structure of the stator unit 2 in the energy-generating device of the present invention is shown, wherein the stator unit 2 comprises multiple annular steel sheets 21, the positioning post 22, multiple dividing boards 23, multiple insulating sheets 24, the inner coil 25 and the outer coil 26.

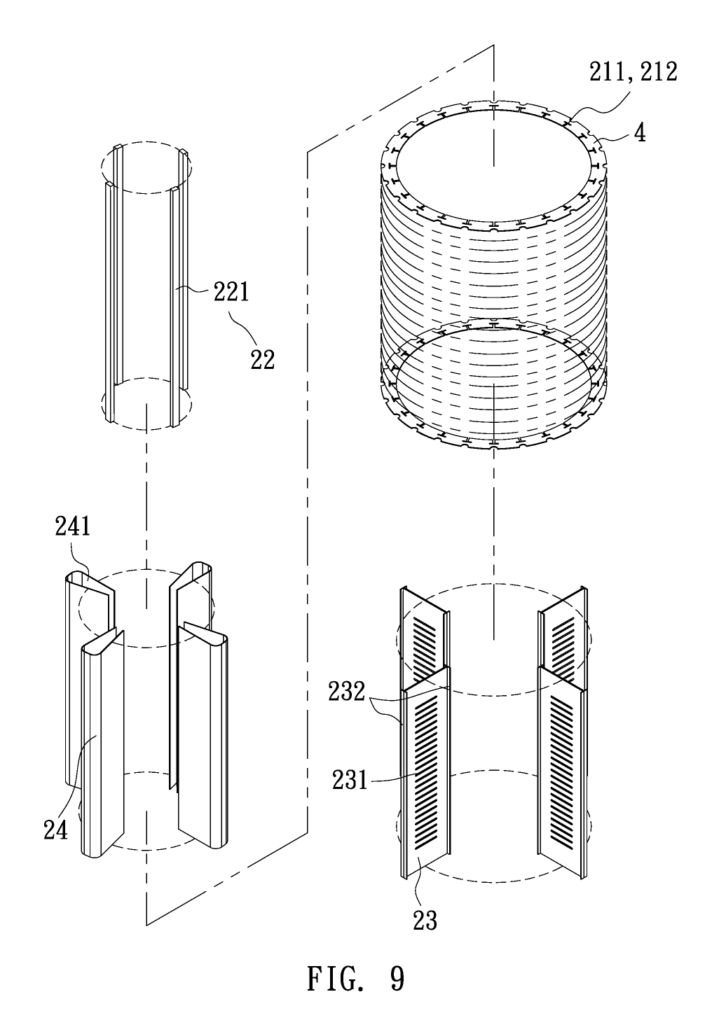

The multiple annular steel sheets 21 each have multiple T-shaped openings 211 defined on inner edge thereof. The multiple annular steel sheets 21 are stacked up into a cylinder and the multiple T-shaped openings 211 on one annular steel sheet 21 are aligned with other T-shaped openings 211 on the other annular steel sheets 21 to perform T-shaped recesses 212 in the cylinder, as shown in FIG. 9.

The positioning post 22 comprises multiple positioning strips 221 arranged in circle on top of the positioning post 22 as shown in FIG. 9 and multiple positioning recesses 222 defined each between adjacent two of the multiple positioning strips 221.

Each of the multiple dividing boards 23 has multiple slits 231. Two ends of each dividing board 23 respectively have a rib 232 as shown in FIG. 9. The ribs 232 on the two ends of the dividing board 23 respectively engage the corresponding T-recess 212 of the multiple annular steel sheets 21 and the corresponding positioning recess 222 on the positioning post 22.

Multiple insulating sheets 24 are located each between adjacent two of the multiple dividing boards 23, as shown in FIG. 9 and shaped in U-shape. Two distal ends of each U-shaped insulating sheet 24 at opening are inserted into two adjacent positioning recesses 222 on the positioning post 22 so that each insulating sheet 24 has a space 241 to accommodate the inner coil 25 and the outer coil 26 penetrating the space 241.

Numbers of the multiple T-recesses 212 and the multiple positioning recesses 222 are corresponding (same) to the number of the multiple dividing boards 23.

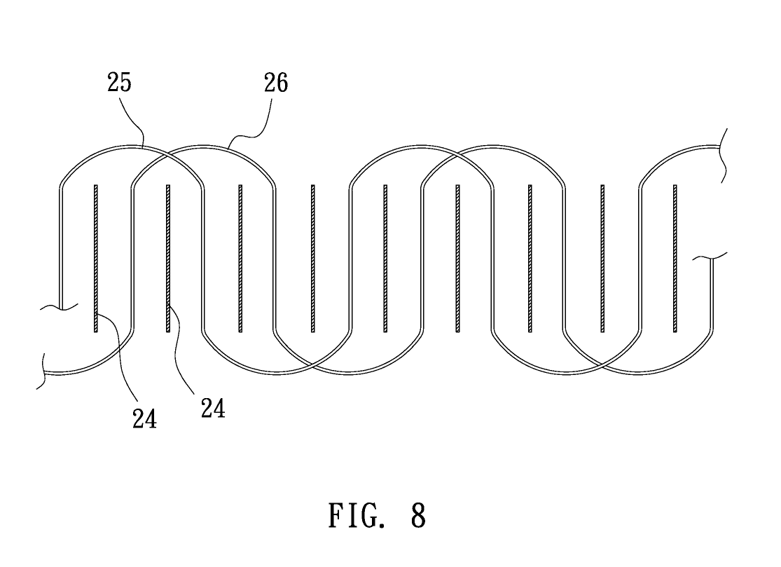

With regard to the winding and structure of the inner coil 25 and the outer coil 26, both are described below as shown in FIGS. 5, 7 and 8.

The inner coil 25 of the stator unit 2 penetrates one space 241 of one insulating sheet 24, crosses over the adjacent first insulating sheet 24 and then penetrates the adjacent second insulating sheet 24 repeatedly. The inner coil 25 is located inside the space 241 of the insulating sheets 24 and close to the positioning post 22 inner.

The outer coil 26 of the stator unit 2 penetrates one space 241 of one insulating sheet 24 without containing the inner coil 25, crosses over the adjacent first insulating sheet 24 and then penetrates the adjacent second insulating sheet 24 repeatedly. The outer coil 26 is located inside the space 241 of the insulating sheets 24 and close to the multiple annular steel sheets 21 outer.

As shown in FIG. 10, a schematic drawing of application comprises the electricity-generating device 4 having the rotator unit 1 and the stator unit 2 which is connected to the drive motor 6 by the shaft 13 (as shown in FIG. 1) and receives the power from the drive motor 6 to make the rotator unit 1 rotate inside the stator unit 2. By continuously shearing the magnetic lines to perform magnetic inducement and generate induced current output, the current supplies charge of battery (small quantity electricity) and outer electricity consumption (large quantity electricity) such as industrial electricity consumption, commercial electricity consumption and household electricity consumption.

A battery 5 connected to the driven motor 6 must have sufficient initial electricity to actuate the electricity-generating device 4 to start the electricity-generating process. Once the electricity-generating device starts generating electricity, it continues to charge the battery 5 and then the electricity of the battery drives the drive motor 6 to perform electricity-generating process with cyclic efficiency. The electricity output of the electricity-generating device 4 will be continued without interruption theatrically and only to be stopped until one of the battery 5, the drive motor 6 or the electricity-generating device 4 needs to be repaired or replaced.

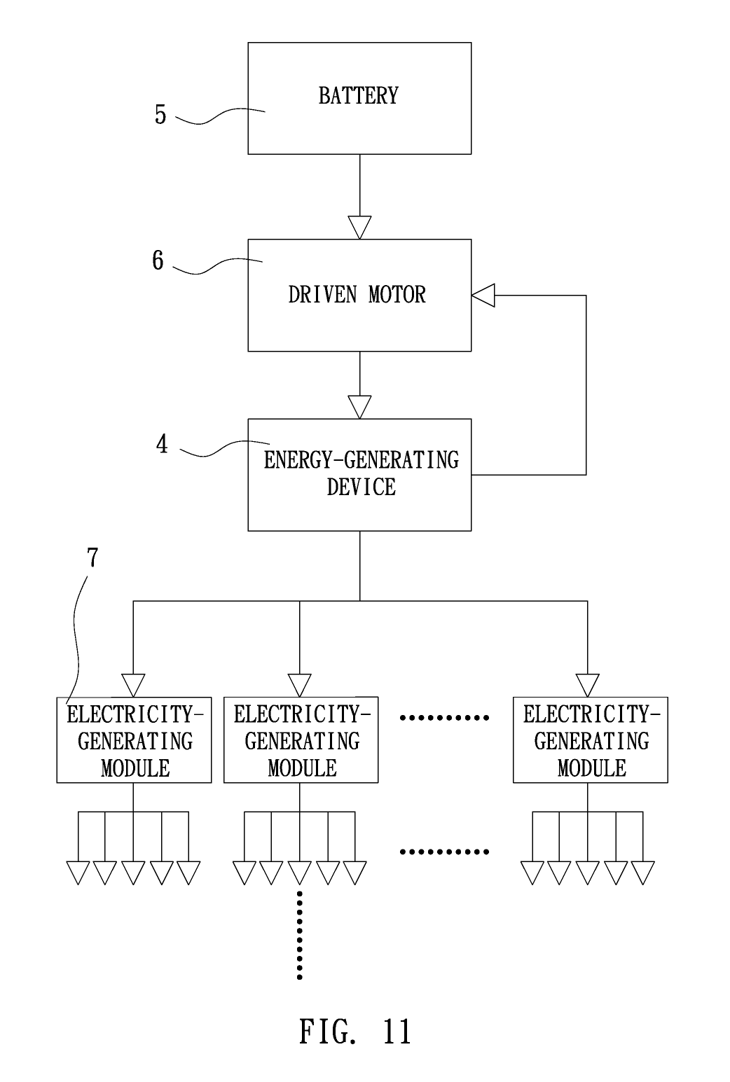

As shown in FIG. 11, a schematic drawing of the electricity-generating construction with cyclic expansion comprises the electricity-generating device 4 as described above to supply general outer electricity consumption (industrial electricity, commercial electricity, and household electricity) and to operationally connect with multiple electricity-generating modules 7 in parallel, wherein each electricity-generating module is composed of an electricity-generating device 4, a battery 5, and a drive motor 6. The electricity-generating device 4 branches to connect with multiple electricity-generating modules 7 unlimited in augmentation to collect large electricity output.

According to above description, the advantages of the present invention are listed below.

1. Without using nature resources (hydraulic power, fire power or nuclear power etc.) to generate electricity, electricity-generating cost is significantly reduced and environment-friendly to reduce carbon-emission.

2. By attaching more than one electricity-generating modules respectively providing different quantity of electricity for different application consumption, the combination of the electricity-generating device can be arranged into different sizes for different spaces.

3. Users enable to adjust the scale of the electricity-generating device to meet different electricity requirement in different places so that the electricity-generating device has variety in arrangement for all-aspect and flexible applications.

4. The electricity-generating device only needs small quantity electricity to actuate, has high energy efficiency and can be downsized in scales and size of relative elements to significantly reduce electricity-generating cost.

5. The slits defined on the dividing boards of the stator unit sufficiently reduce power consumption caused by wind pressure or magnetic retard when the rotator rotates so that electricity-generating efficiency in improved.

6. By having the winding structure alternative with interval, the inner coil and the outer coil has more sufficient coil numbers and increased magnetic density to improve effective magnetic inducement when the magnetic field changes.

Although this invention has been described in its preferred form with a certain degree of particularity, it is understood that the present invention of the preferred form has been made only by way of example and that numerous changes in the details of construction and the combination and arrangement of parts any be resorted to without departing from the spirit and scope of the invention.

What is claimed is:

1. An electricity-generating device comprising:
a rotator unit having a rotator, multiple magnetic strips and a shaft, wherein the shaft penetrates the rotator and the multiple magnetic strips are mounted around an cylindrical surface of the rotator;
a stator unit having multiple annular steel sheets, a positioning post, multiple dividing boards, multiple insulating sheets, an inner coil and an outer coil; wherein the each of the multiple annular steel sheets has multiple T-shaped openings; the multiple annular steel sheets are stacked to make the T-shaped openings communicated to perform multiple T-shaped recesses; the positioning post has multiple positioning strips erectly arranged in circle cross-section and multiple positioning recesses are defined each between adjacent two of the multiple positioning strips; each of the multiple dividing boards has multiple slits and two side ends having two ribs respectively to engage with a corresponding one of the multiple T-shaped recesses and the corresponding post of the multiple positioning recesses respectively; each of the multiple insulating sheets is clamped between adjacent two of the multiple dividing boards and shaped in U-shape having a space and two distal ends at opening respectively inserted into adjacent two of the multiple positioning recesses; the space accommodates the inner coil or the outer coil penetrating the space; and
two caps mounted on two ends of the shaft respectively and each having an end hole and a bearing around the end hole.

2. The electricity-generating device as claimed in claim 1, wherein the rotator of the rotator unit is solid or hollow in interior.

3. The electricity-generating device as claimed in claim 2, wherein two ends of the rotator are mounted with two propellers respectively when the rotator is hollow.

4. The electricity-generating device as claimed in claim 1, wherein the multiple magnetic strips are same length with the rotator but each divided into multiple even sections.

5. The electricity-generating device as claimed in claim 1, wherein numbers of the multiple T-recesses and the multiple positioning recesses are corresponding to the number of the multiple dividing boards.

6. The electricity-generating device as claimed in claim 1, wherein the inner coil of the stator unit penetrates one space of one insulating sheet, crosses over the adjacent first insulating sheet and then penetrates the adjacent second insulating sheet repeatedly.

7. The electricity-generating device as claimed in claim 6, wherein the inner coil is located inside the spaces of the insulating sheets and close to the positioning post.

8. The electricity-generating device as claimed in claim 1, wherein the outer coil of the stator unit penetrates one space of one insulating sheet without containing the inner coil, crosses over the adjacent first insulating sheet and then penetrates the adjacent second insulating sheet repeatedly.

9. The electricity-generating device as claimed in claim 8, wherein the outer coil is located inside the spaces of the insulating sheets and close to the multiple annular steel sheets.
